(19) United States
(12) Patent Application Publication
(10) Pub. No.: US 2007/0290932 A1
(43) Pub. Date: Dec. 20, 2007

(54) Mobile device with protective antenna cover

(76) Inventors: Quintin Morris, Brooklyn, NY (US); Katrika Woodcock, Brooklyn, NY (US); Jorg Schlieffers, Streatley-on-Thames (GB); Christopher N. Crawford, Glen Clove, NY (US); Robert J. Kowalski, Commack, NY (US)

Correspondence Address: FAY KAPLUN & MARCIN, LLP, 15O BROADWAY, SUITE 702, NEW YORK, NY, 10038, US

(21) Appl. No.: 11/455,539

(22) Filed: Jun. 19, 2006

(51) Int. Cl. H01Q 1/24

(52) U.S. Cl. 343/702

(57) ABSTRACT

Described is a mobile device with a protective antenna cover. The mobile device comprises a housing, an antenna and an antenna cover. The housing encloses electronic components of the device including at least one of a transmitter and a receiver. The antenna is coupled to the one of a transmitter and a receiver. The antenna cover is ultrasonically welded to the housing. The antenna cover defines an interior space within which at least a part of the antenna is received. The interior space is sized so that the part of the antenna received therewithin is separated from an inner surface of the antenna cover around an entire circumference thereof.

### FIELD OF THE INVENTION

The present invention generally relates to mobile devices with antennas.

### BACKGROUND INFORMATION

Mobile devices are subject to frequent handling by users and are consequently damaged by being dropped, struck by or against another object, or simply mishandled. One feature of many mobile devices is an antenna enabling these devices to transmit and/or receive signals.

A conventional method of protecting the antenna is to cover the antenna with a protective layer such as a plastic coating. However, if sufficient force is applied thereto, the coating (and consequently the antenna) may bend or snap, damaging the device.

### SUMMARY OF THE INVENTION

The present invention relates to a mobile device with a protective antenna cover. The mobile device comprises a housing, an antenna and an antenna cover. The housing encloses electronic components of the device including at least one of a transmitter and a receiver. The antenna is coupled to the one of a transmitter and a receiver. The antenna cover is ultrasonically welded to the housing. The antenna cover defines an interior space within which at least a part of the antenna is received. The interior space is sized so that the part of the antenna received therewithin is separated from an inner surface of the antenna cover around an entire circumference thereof.

### BRIEF DESCRIPTION OF THE DRAWINGS

FIG. 1 is an exemplary embodiment of a mobile device according to the present invention;

FIG. 2 is a partial side view of the mobile device of FIG. 1;

FIG. 3 is a partial cross-sectional view of the mobile device of FIG. 1 along line A-A; and

FIG. 4 is a top view of an interior portion of the antenna cover of the device of FIG. 1.

### DETAILED DESCRIPTION

The present invention may be further understood with reference to the following description and the appended drawings, wherein like elements are provided with the same reference numerals. The present invention relates to mobile devices (e.g., mobile units, (“MUs”)) with antennas. An exemplary embodiment of the present invention is described with reference to an MU with a barcode scanner, however those skilled in the art will understand that the present invention may be implemented with any type of antenna-based MU such as, for example, an RFID reader, a cell phone, a PDA, a laptop, an image-/laser-based scanner, a network interface card, etc.

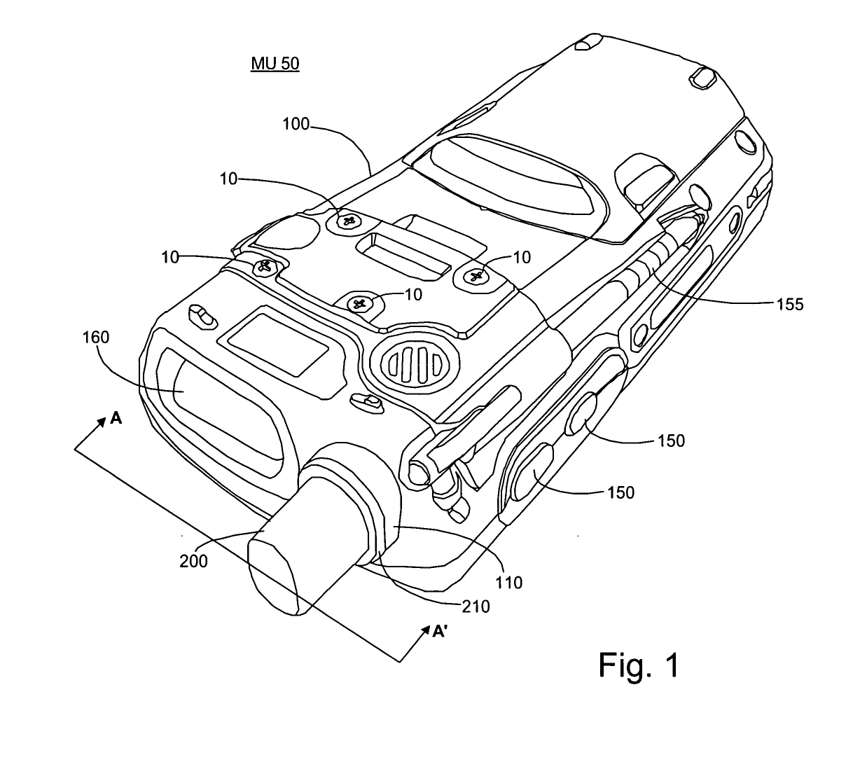

FIG. 1 shows an exemplary embodiment of an MU 50 according to the present invention. The MU 50 includes a scanner (e.g., a barcode scanner 160) as well as one or more user input devices, such as a keypad, push buttons 150, a stylus 155, etc. The MU 50 may further include a display (e.g., an LCD) and computing components such as a processor, a memory, a hard drive, a wireless communications arrangement (e.g., a wireless transmitter and/or receiver), etc.

The wireless communications arrangement includes an antenna 300 (shown in FIG. 3) which transmits and/or receives radio frequency (“RF”) signals to/from another device (e.g., an access point). In the exemplary embodiment, the antenna 300 is substantially tubular in shape. However those skilled in the art will understand that the antenna 300 may have any other shape such as, for example, helical, “T”, parabolic, rectangular, etc. without departing from the scope of the invention. The antenna 300 may be any type of antenna including, but not limited to, a quarter wave, half-wave, co-linear and patch antenna. Furthermore, as would be understood by those skilled in the art, the antenna 300 may be formed of any material(s) suitable for transmitting and receiving radio waves, such as aluminum, steel, copper, fiberglass, etc.

As shown in FIG. 1, the MU 50 includes a housing 100 and an antenna cover 200. The housing 100 may be constructed of any number of materials, but is preferably formed of a durable plastic or rubber material using a conventional method such as, for example, injection or extrusion molding. The housing 100 may be formed integrally, or as a composite of two or more pieces. For example, the housing 100 may comprise two pieces held together using one or more screws 10. Other attachment methods, such as snap fitting, adhesive bonding, etc. may also be used in conjunction with or as an alternative to screws.

In an exemplary embodiment, the antenna cover 200 is formed using the same or similar materials and methods as the housing 100. For example, the antenna cover 200 may be formed using a substantially rigid polymer that undergoes little or no deformation when subjected to temperatures consistent with an operating environment of the MU 50. In other embodiments, the antenna cover 200 may be formed of a substantially different material from that of which the housing 100 is formed. For example, the material may be more or less rigid than that used for the housing 100, the material may have different temperature response, different density, etc.

Thicknesses of the antenna cover 200 and the housing 100 are preferably selected based on physical characteristics of the MU 50 (e.g., size, weight, etc.) and/or based on the operating environment (e.g., industrial environments may require greater thicknesses than home environments). As would be understood by those skilled in the art, larger thicknesses may increase rigidity and/or enhance shock absorption, while smaller thicknesses may decrease the size and/or weight of the MU 50, making it easier to handle.

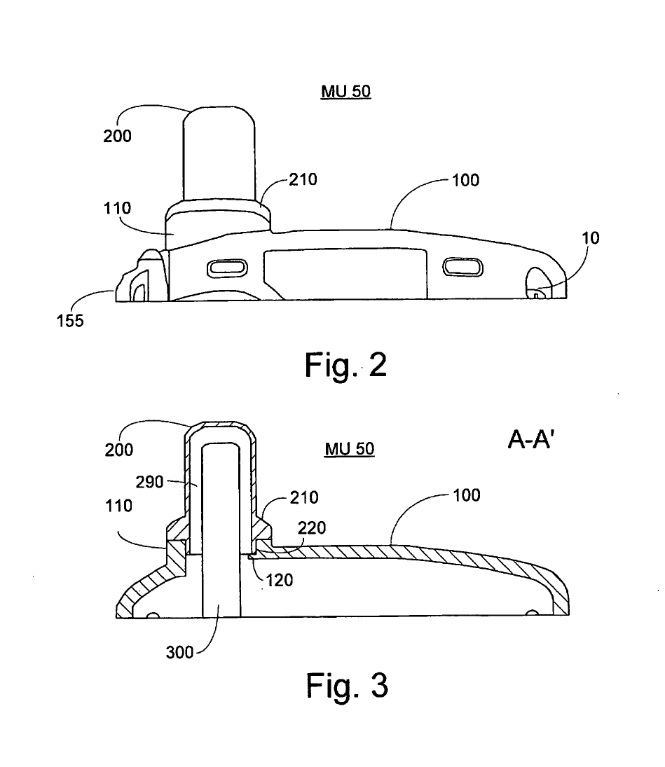

A shown in FIG. 2, the antenna cover 200 which is mated to the housing 100, includes an optional collar portion 210 which is attached to a receiving shoulder 110 of the housing 100. The collar 210 may be permanently attached to the shoulder 110 via ultrasonic welding. For example, an ultrasonic signal may be applied to the shoulder 110 and/or the collar 210, thereby heating a surface thereof and causing the surface to bond to a mating surface of an opposing piece. After the ultrasonic signal is removed, the piece(s) rapidly cools and a permanent bond is formed. The permanent bond may form a tight seal around the pieces 110, 210 that is substantially gas and/or liquid impermeable. In other embodiments, alternative bonding methods such as adhesives (e.g., glue) may be used to perform the attaching.

As shown in FIG. 3, the antenna 300 is enclosed within a hollow portion of the antenna cover 200 and extends into interior portion of the housing 100. In an exemplary embodiment, the antenna cover 200 completely surrounds the antenna 300 without contacting any portion thereof. For example, a space 290 around the antenna 300 comprises a buffer zone or sway space which in an exemplary embodiment of the invention, is filled with air. However in other embodiments, the space 290 may be partially or entirely filled with any radio-conductive complaint material (e.g., a shock-absorbing polymer, an inflatable membrane, etc.). Thus, if the antenna cover 200 is subjected to an external force (e.g., an impact) the space 290 allows the antenna cover 200 to be deformed without transferring the force to the antenna 300. In addition, if the external force is sufficient to separate the antenna cover 200 from the housing 100, the space 290 allows the antenna cover 200 to be partially or entirely displaced without contacting the antenna 300.

As shown in FIG. 3, the antenna cover 200 includes an inner end 220 which extends into a hole in the shoulder 110 to, for example, contact and/or mate with the shoulder 110 to which it may be ultrasonically welded. In an exemplary embodiment a shown in FIG. 3, the inner end 220 does not extend past an end of the shoulder 110, and the inner end 220 terminates with a small gap between an innermost surface of the inner end 220 and an innermost surface of the shoulder 110. However, in other embodiments the inner end 220 may extend past the shoulder 110 into the interior portion of the housing 100.

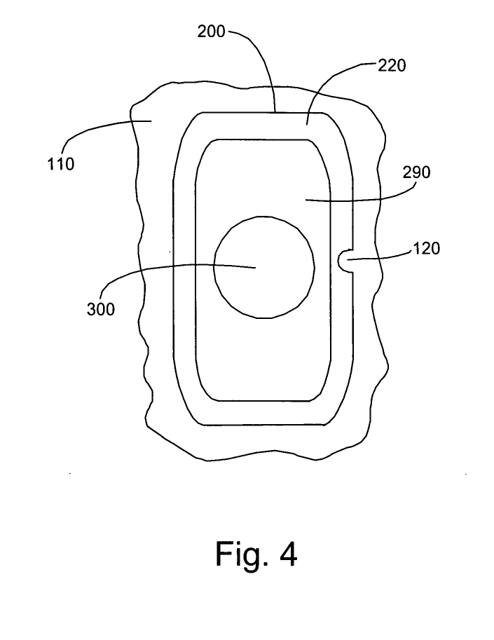

As shown in FIG. 4, the antenna cover 200 may mate with the shoulder 110 without any spacing there between and with the antenna cover 200 completely surrounding the antenna 300 while separated there from around its entire circumference by the space 290. One or more ridges 120 of the housing 100 may extend laterally into the inner end 220 towards the antenna 300 so long as a minimum desired clearance of the space 290 is maintained.

As shown, the ridge 120 extends only partially into the inner end 220, terminating before the sway space 290. In other embodiments, the ridge 120 may extend into the sway space 290 without contacting the antenna 300. The ridge 120 may provide additional structural support for the antenna cover 220 by, for example, resisting inwardly directed compressive forces while providing stability by restricting longitudinal displacement of the antenna cover 200. Although in the exemplary embodiment only one ridge 120 is utilized, in other embodiments a plurality of ridges 120 may be placed along a perimeter of the innermost surface of the inner end 220. For example, at each corner of the innermost surface of the inner end 220, along a middle of each side of the innermost surface of the inner end 220, etc.

As previously discussed, the antenna cover 200 may be ultrasonically welded to the housing 100 to form a permanent bond between any surface (e.g., an inner surface of the collar 210, a lateral surface of the inner portion 220, etc.) of the antenna cover 200 and the shoulder 110 and/or the ridge 120. This provides an extremely strong bond which is stable and resists external forces. For example, if the force is a pulling force directed outward against the antenna cover 200, the force may be transferred to part or all of the housing 100 and dispersed, since the antenna cover 200 and the housing 100 act as a single structure. If the force is a compressive force, it may also be transferred to the housing 100 and dispersed.

Dispersal of the force may cause a portion of the housing 100 which is weaker relative to the antenna cover 200 and/or the shoulder 110 (e.g., which has been intentionally weakened) to yield. For example, the force may cause the weaker portion to break (e.g., crack, deform, snap, etc.) and dispose the force before the antenna cover 200 is damaged, thereby preventing damage to the antenna 300. Thus, the housing 100 may be designed to include one or more weaker portions in non-critical areas of the MU 50, where breakage would not cause permanent damage and/or impairment of functionality.

Alternatively, according to an exemplary embodiment the designer may choose to make the housing 100 stronger than the antenna cover 200, allowing the cover 200 to yield before the housing 100. So long as the space 290 prevents damage to the antenna 300, the antenna cover 200 may be replaced. In other embodiments, the antenna cover 200 and the housing 100 may be equally strong so that external forces applies to the antenna cover 200, cause the ultrasonic weld to yield separating the antenna cover 200 from the housing 100 to disperse the force.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A mobile device, comprising:
a housing enclosing electronic components of the device including at least one of a transmitter and a receiver;
an antenna coupled to the one of a transmitter and a receiver; and
an antenna cover ultrasonically welded to the housing, the antenna cover defining an interior space within which at least a part of the antenna is received, wherein the interior space is sized so that the part of the antenna received therewithin is separated from an inner surface of the antenna cover around an entire circumference thereof.

2. The mobile device according to claim 1, wherein an inner end of the antenna cover extends into the housing through a hole formed therein and wherein the antenna cover includes a collar extending radially outward at a location between the inner end and an outer end of the antenna cover, the collar being ultrasonically welded to a portion of the housing surrounding the hole.

3. The mobile device according to claim 2, wherein the housing defines at least one abutting member projecting into the hole to support the inner end of the antenna cover thereon.

4. The mobile device according to claim 3, wherein the antenna cover includes at least one slot receiving a corresponding one of the at least one abutting member.

5. The mobile device according to claim 1, wherein the mobile device includes at least one of a laser-based scanner, an imager-based scanner, an RFID reader, a mobile phone, a PDA and a network interface card.

6. The mobile device according to claim 1, wherein the antenna cover is formed from one of plastic and rubber.

7. The mobile device according to claim 1, wherein a space surrounding the antenna within the interior space of the antenna cover is filled with one of air, a shock-absorbent polymer and an inflatable membrane.

8. A mobile device, comprising:
a housing enclosing electronic components of the device including at least one of a transmitter and a receiver;
an antenna coupled to the one of a transmitter and a receiver; and
an antenna cover coupled to the housing, the antenna cover defining an interior space within which at least a part of the antenna is received, wherein the interior space is sized so that the part of the antenna received therewithin is separated from an inner surface of the antenna cover around an entire circumference thereof.

9. The mobile device according to claim 8, wherein the antenna cover is coupled to the housing via one of a mechanical coupling, an adhesive and ultrasonic welding.

10. The mobile device according to claim 8, wherein an inner end of the antenna cover extends into the housing through a hole formed therein and wherein the antenna cover includes a collar extending radially outward at a location between the inner end and an outer end of the antenna cover, the collar being ultrasonically welded to a portion of the housing surrounding the hole.

11. The mobile device according to claim 10, wherein the housing defines at least one abutting member projecting into the hole to support the inner end of the antenna cover thereon.

12. The mobile device according to claim 11, wherein the antenna cover includes at least one slot receiving a corresponding one of the at least one abutting member.

13. The mobile device according to claim 8, wherein the mobile device includes at least one of a laser-based scanner, an imager-based scanner, an RFID reader, a mobile phone, a PDA and a network interface card.

14. The mobile device according to claim 8, wherein a space surrounding the antenna within the interior space is filled with one of air, a shock-absorbent polymer and an inflatable membrane.

15. An antenna cover, comprising:
an enclosure defining an interior space within which at least a part of an antenna of a mobile computing device is received, wherein the interior space is sized so that, when the enclosure is ultrasonically welded to the mobile computing device, the part of the antenna received within the enclosure is separated from an inner surface of the enclosure around an entire circumference of the part of the antenna.

16. The antenna cover according to claim 15, wherein an inner end of the enclosure extends into a housing of the mobile computing device through a hole formed therein.

17. The antenna cover according to claim 16, further comprising:
a collar extending radially outward at a location between the inner end and an outer end of the enclosure, the collar being ultrasonically welded to a portion of the housing surrounding the hole.

18. The antenna cover according to claim 17, further comprising:
at least one ridge-receiving slot receiving at least one ridge formed on the housing to support the inner end of the enclosure thereon.

19. The antenna cover according to claim 15, wherein a space surrounding the antenna within the interior space is filled with one of air, a shock-absorbent polymer and an inflatable membrane.

20. A mobile device, comprising:
a housing means for enclosing electronic components of the device including at least one of a transmitter and a receiver;
an antenna means coupled to the one of a transmitter and a receiver; and
a cover means ultrasonically welded to the housing, the cover means defining an interior space within which at least a part of the antenna means is received, wherein the interior space is sized so that the part of the antenna means received therewithin is separated from an inner surface of the cover means around an entire circumference thereof.
